(19) United States
(12) Patent Application Publication
(10) Pub. No.: US 2010/0081064 A1
(43) Pub. Date: Apr. 1, 2010

(54) NON-AQUEOUS ELECTROLYTE BATTERY

(75) Inventor: Mikio Watanabe, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/570,226

(22) Filed: Sep. 30, 2009

(30) Foreign Application Priority Data
Sep. 30, 2008 (JP) P2008-252889

(51) Int. Cl. H01M 6/16

(52) U.S. Cl. 429/338

(57) ABSTRACT

A non-aqueous electrolyte battery includes: a positive electrode containing a lithium phosphate compound having an olivine structure; a negative electrode containing a negative electrode active material capable of doping and dedoping lithium; and a non-aqueous electrolyte, the non-aqueous electrolyte containing a cyclic carbonate derivative represented by the following formula (1) and 1,2-dimethoxyethane

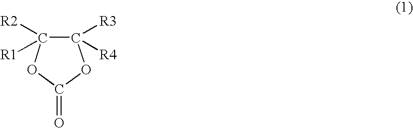

wherein R1 to R4 each independently represents a hydrogen group, a fluorine group, an alkyl group or a fluoroalkyl group, and at least one of R1 to R4 contains fluorine.

### CROSS REFERENCES TO RELATED APPLICATIONS

The present application claims priority to Japanese Priority Patent Application JP 2008-252889 filed in the Japan Patent Office on Sep. 30, 2008, the entire contents of which is hereby incorporated by reference.

### BACKGROUND

The present application relates to a non-aqueous electrolyte battery. In more detail, the present application relates to a non-aqueous electrolyte battery containing a lithium phosphate compound having an olivine structure in a positive electrode.

In recent years, a number of portable electronic appliances, for example, camera-integrated VTR (video tape recorders), cellular phones and laptop computers, each achieving a reduction in size and weight, have appeared. As portable power sources for such electronic appliances, research and development for enhancing an energy density regarding batteries, in particular, secondary batteries are being actively advanced.

Batteries using a non-aqueous electrolytic solution, in particular, lithium ion secondary batteries are high in expectations because a large energy density is obtainable as compared with lead batteries and nickel-cadmium batteries as existing aqueous solution based electrolytic solution secondary batteries, and their market is conspicuously growing.

Especially, in recent years, characteristic features of lithium ion secondary batteries, such as light weight and high energy density, are suited for applications to electric vehicles and hybrid electric vehicles, and therefore, investigations for realizing enlargement and high output of the battery are eagerly carried out.

In non-aqueous secondary batteries represented by lithium ion secondary batteries, it is general to use a positive electrode made of, as a positive electrode active material, an oxide such as LiCoO₂, LiNiO₂ and LiMn₂O₄. This is because they attain a high capacity and a high voltage and are excellent in high filling properties, and therefore, they are advantageous for achieving a reduction in size and weight of portable appliances.

However, when such a positive electrode is heated in a charged state, it starts to deintercalate oxygen at 200° C. to 300° C. When the deintercalation of oxygen starts, there is a danger that the battery causes thermorunaway because it uses an inflammable organic electrolytic solution as the electrolytic solution. Accordingly, in the case of using an oxide positive electrode, it is not easy to secure stability especially in large-sized batteries.

On the other hand, in a positive electrode material having an olivine structure as reported by A. K. Padhi, et al., it is expressed that even when the temperature exceeds 350° C. the positive electrode material does not deintercalate oxygen so that it is very excellent in stability (see J. Electrochem. Soc., Vol. 144, page 1188).

The positive electrode material having an olivine structure has such characteristic features that not only a charge and discharge region is relatively low as approximately 3.2 V, but conductivity is low. In order to compensate this lowness in conductivity, it is effective to mix 1,2-dimethoxyethane in an electrolytic solution. This is because the conductivity of the electrolytic solution is enhanced by the addition of 1,2-dimethoxyethane. However, in this 1,2-dimethoxyethane, oxidative decomposition is easy to proceed, and therefore, it could not be used in existing 4V class positive electrode materials.

In a lithium phosphate compound having an olivine structure, since a charge and discharge potential is relatively low, such oxidative decomposition hardly proceeds. JP-A-2006-236809 discloses a secondary battery including a mixture layer containing a positive electrode active material containing lithium iron phosphate (LiFePO₄), a conductive agent and a binder in a positive electrode, in which the positive electrode has a mixture filling density of the mixture layer after the formation of electrode of 1.7 g/cm³ or more; and a non-aqueous electrolytic solution including a solvent containing ethylene carbonate and a chain ether such as 1,2-dimethoxyethane.

### SUMMARY

However, according to investigations made by the present inventor, there was found a problem that when an excessively large amount of 1,2-dimethoxyethane is used, reversibility of a carbon material which is used for a negative electrode is impaired, resulting in a lowering of charge and discharge efficiency or cycle characteristic. It was noted that the lowering of charge and discharge efficiency in the negative electrode becomes conspicuous; and further that when 1,2-dimethoxyethane is added in an amount of 10% by volume or more to an electrolytic solution, the battery capacity is largely lowered.

Accordingly, it is desirable to provide a non-aqueous electrolyte battery in which in the case of using a lithium phosphate compound having an olivine structure as a positive electrode material, even when an electrolytic solution containing 1,2-dimethoxyethane is used, a phenomenon where reversibility of a negative electrode material is lowered can be suppressed, and deterioration in charge and discharge efficiency or cycle characteristic can be suppressed.

According to investigations made by the present inventor, the technology proposed in the foregoing JP-A-2006-236809 involved a problem that when an excessively large amount of 1,2-dimethoxyethane is used, reversibility of a carbon material which is used for a negative electrode is impaired, resulting in a lowering of charge and discharge efficiency or cycle characteristic. It was noted that the lowering of charge and discharge efficiency in the negative electrode becomes conspicuous and that when 1,2-dimethoxyethane is added in an amount of 10% by volume or more to an electrolytic solution, the battery capacity is largely lowered.

On the other hand, as a result of extensive and intensive investigations made by the present invention, it has been found that by adding a fluorine-containing cyclic carbonate derivative such as 4-fluoro-1,3-dioxolan-2-one to an electrolytic solution, even when 1,2-dimethoxyethane is mixed, a phenomenon where reversibility of a negative electrode carbon material is lowered is suppressed, whereby the addition amount of 1,2-dimethoxyethane can be increased.

According to an embodiment, there is provided a non-aqueous electrolyte battery including a positive electrode containing a lithium phosphate compound having an olivine structure, a negative electrode containing a negative electrode active material capable of doping and dedoping lithium and a non-aqueous electrolyte, the non-aqueous electrolyte containing a cyclic carbonate derivative represented by the following formula (1) and 1,2-dimethoxyethane.

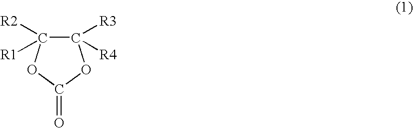

In the foregoing formula (1), R1 to R4 each independently represents a hydrogen group, a fluorine group, an alkyl group or a fluoroalkyl group, and at least one of R1 to R4 contains fluorine.

According to an embodiment, when a fluorine-containing cyclic carbonate derivative such as 4-fluoro-1,3-dioxolan-2-one to an electrolytic solution, even when 1,2-dimethoxyethane is mixed, a phenomenon where reversibility of a negative electrode carbon material is lowered is suppressed, whereby not only the addition amount of 1,2-dimethoxyethane can be increased, but conductivity of the electrolytic solution can be more enhanced. Low conductivity as seen in the case of using a positive electrode material having an olivine structure can be compensated.

According to an embodiment, in the case of using a positive electrode material having an olivine structure for a positive electrode, even when an electrolytic solution containing 1,2-dimethoxyethane is used, a phenomenon where reversibility of a negative electrode material is lowered can be suppressed, and deterioration in charge and discharge efficiency or cycle characteristic can be suppressed.

Additional features and advantages are described herein, and will be apparent from the following Detailed Description and the figures.

### BRIEF DESCRIPTION OF THE FIGURES

FIG. 1 is a sectional view showing a configuration of a non-aqueous electrolytic solution battery according an embodiment.

FIG. 2 is a sectional view showing enlargedly a part of a wound electrode body shown in FIG. 1.

FIG. 3 is a graph summarizing initial charge and discharge efficiencies of Samples 1 to 13.

FIG. 4 is a graph summarizing capacity retention rates at the time of 500 cycles of Samples 1 to 13.

FIG. 5 is a graph summarizing direct current resistances of Samples 1 to 13.

FIG. 6 is a chart graph summarizing a recovered capacity of Samples 3 and 8.

### DETAILED DESCRIPTION

The present application is described with reference to the accompanying drawings according to an embodiment.

[Configuration Example of Lithium Ion Secondary Battery]

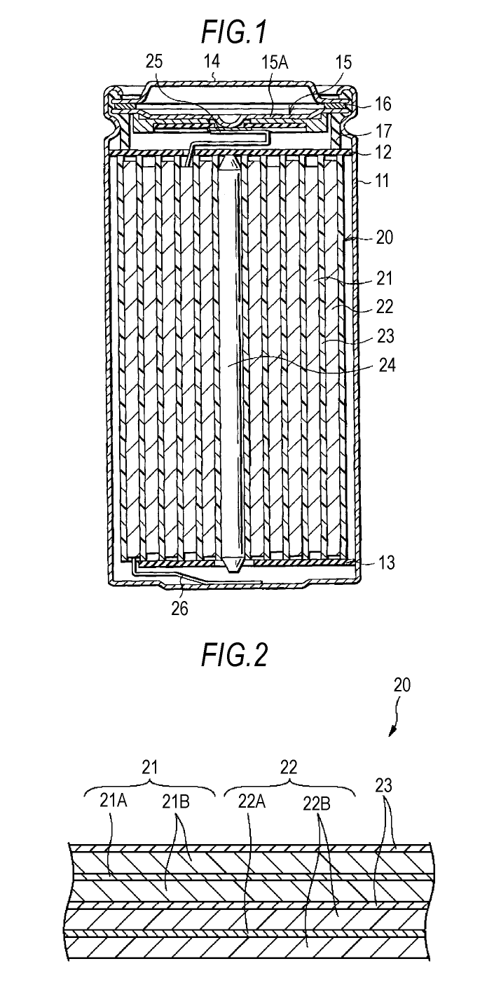

FIG. 1 shows a sectional view of a non-aqueous electrolytic solution battery according an embodiment. This battery is, for example, a non-aqueous electrolytic solution secondary battery and, for example, a lithium ion secondary battery.

As shown in FIG. 1, this secondary battery is called a cylinder type and has a wound electrode body 20 having a strip-shaped positive electrode 21 and a strip-shaped negative electrode 22 wound therein via a separator 23 in the inside of a substantially hollow columnar battery can 11. The battery can 11 is constituted of, for example, iron (Fe) plated with nickel (Ni), and one end thereof is closed, with the other end being opened. A pair of insulating plates 12 and 13 is disposed so as to vertically interpose the wound electrode body 20 therebetween relative to the wound peripheral surface thereof in the inside of the battery can 11.

In the open end of the battery can 11, a battery lid 14 and a safety valve mechanism 15 and a positive temperature coefficient element (PTC element) 16 each provided on the inside of this battery lid 14 are installed by caulking via a gasket 17, and the inside of the battery can 11 is hermetically sealed. The battery lid 14 is made of, for example, a material the same as that in the battery can 11.

The safety valve mechanism 15 is electrically connected to the battery lid 14 via the positive temperature coefficient element 16, and in the case where the internal pressure reaches a fixed value or more due to an internal short circuit or heating from the outside or the like, a disc plate 15A is reversed, whereby electrical connection between the battery lid 14 and the wound electrode body 20 is disconnected. When the temperature increases, the positive temperature coefficient element 16 controls the current due to an increase of a resistance value, thereby preventing abnormal heat generation to be caused due to a large current. The gasket 17 is made of, for example, an insulating material, and asphalt is coated on the surface thereof.

The wound electrode body 20 is wound centering on, for example, a center pin 24. In this wound electrode body 20, a positive electrode lead 25 made of aluminum (Al) or the like is connected to the positive electrode 21; and a negative electrode lead 26 made of nickel (Ni) or the like is connected to the negative electrode 22. The positive electrode lead 25 is electrically connected to the battery lid 14 by means of welding to the safety valve mechanism 15; and the negative electrode lead 26 is electrically connected to the battery can 11 by means of welding.

FIG. 2 is a sectional view showing enlargedly a part of the wound electrode body 20 shown in FIG. 1. The positive electrode 21 has, for example, a positive electrode collector 21A having a pair of opposing surfaces and a positive electrode active material layer 21B which is provided on the both surfaces of the positive electrode collector 21A. The positive electrode 21 may be configured to include a region where the positive electrode active material layer 21B is present on only one surface of the positive electrode collector 21A. The positive electrode collector 21A is made of a metal foil, for example, an aluminum (Al) foil, etc.

The positive electrode active layer 21B contains, for example, a positive electrode active material and may contain a conductive agent such as carbon black and graphite and a binder such as polyvinylidene fluoride as the need arises. A lithium phosphate compound having an olivine structure is used as the positive electrode active material.

As the lithium phosphate compound having an olivine structure, a lithium phosphate compound having an olivine structure, a charge and discharge potential of which is from about 2.0 V to 3.6 V, is preferable because when the charge and discharge potential is too high, decomposition of 1,2-dimethoxyethan is easy to proceed. Examples of such a lithium phosphate compound include those represented by the general formula: LiFe_{1-y}M_{y}PO₄ (wherein M represents a metal other than a transition metal; and 0≦y≦0.5). Of these, lithium iron phosphate represented by LiFePO₄ is preferable.

The negative electrode 22 has, for example, a negative electrode collector 22A having a pair of opposing surfaces and a negative electrode active material layer 22B which is provided on the both surfaces of the negative electrode collector 22A. The negative electrode 22 may be configured to include a region where the negative electrode active material layer 22B is present on only one surface of the negative electrode collector 22A. The negative electrode collector 22A is made of a metal foil, for example, a copper (Cu) foil, etc.

The negative electrode active material layer 22B contains a negative electrode material capable of doping and dedoping lithium as a negative electrode active material and may contain a binder such as polyvinylidene fluoride as the need arises.

Examples of the negative electrode material capable of intercalating and deintercalating lithium include carbon materials such as graphite, hardly graphitized carbon, easily graphitized carbon, pyrolytic carbons, cokes, vitreous carbons, organic polymer compound baked materials, carbon fibers and active carbon. Of these, examples of the cokes include pitch coke, needle coke and petroleum coke. The organic polymer compound baked material as referred to herein is a material obtained through carbonization by baking a polymer material such as a phenol resin and a furan resin at an appropriate temperature, and a part thereof is classified into hardly graphitized carbon or easily graphitized carbon. Examples of the polymer material include polyacetylene. Such a carbon material is preferable because a change in the crystal structure to be generated at the time of charge and discharge is very little, a high charge and discharge capacity can be obtained, and a favorable cycle characteristic can be obtained. In particular, graphite is preferable because it is able to obtain a large electrochemical equivalent and a high energy density. Also, hardly graphitized carbon is preferable because excellent characteristics are obtainable. Furthermore, a material having a low charge and discharge potential, specially one having a charge and charge potential closed to one of a lithium metal, is preferable because a high energy density of the battery can be easily realized.

Examples of the negative electrode material capable of intercalating and deintercalating lithium include materials capable of intercalating and deintercalating lithium and containing, as a constituent element, at least one member selected from the group consisting of metal elements and semi-metal elements. This is because when such a material is used, a high energy density is obtainable. In particular, a joint use of such a material with a carbon material is more preferable because not only a high energy density is obtainable, but an excellent cycle characteristic is obtainable. This negative electrode material may be a simple substance, an alloy or a compound of a metal element or a semi-metal element, or may be one containing one or two or more phases of the metal element or semi-metal element in at least a part thereof. In the embodiment according to the invention, the “alloy” as referred to herein includes alloys containing at least one member selected from the group consisting of metal elements and at least one member selected from the group consisting of semi-metal elements in addition to alloys composed of two or more kinds of metal elements. Also, the “alloy” may contain a non-metal element. Examples of its texture include a solid solution, a eutectic (eutectic mixture), an intermetallic compound and one in which two or more kinds thereof coexist.

Examples of the metal element or semi-metal element constituting this negative electrode material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). These may be crystalline or amorphous.

Above all, as the negative electrode material, ones containing, as a constituent element, a metal element or a semi-metal element belonging to the Group 4B in the short form of the periodic table are preferable, and ones containing, as a constituent element, at least one of silicon (Si) and tin (Sn) are especially preferable. This is because silicon (Si) and tin (Sn) have large ability for intercalating and deintercalating lithium and are able to obtain a high energy density.

Examples of alloys of tin (Sn) include alloys containing, as a second constituent element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of silicon (Si) include alloys containing, as a second constituent element other than silicon (Si), at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of tin (Sn) or compounds of silicon (Si) include compounds containing oxygen (O) or carbon (C), and these compounds may contain the foregoing second constituent element in addition to tin (Sn) or silicon (Si).

Further examples of the negative electrode material capable of intercalating and deintercalating lithium include other metal compounds and polymer materials. Examples of other metal compounds include oxides such as MnO₂, V₂O₅ and V₆O₁₃; sulfides such as NiS and MoS; and lithium nitrides such as LiN₃. Examples of the polymer material include polyacetylene, polyaniline and polypyrrole.

As the separator 23, for example, a polyethylene porous film, a polypropylene porous film, a synthetic resin-made nonwoven fabric, etc. can be used. An electrolytic solution which is a liquid electrolyte is impregnated in the separator 23.

The electrolytic solution contains a liquid solvent, for example, a non-aqueous solvent such as organic solvents, and an electrolyte salt dissolved in this non-aqueous solvent.

As the non-aqueous solvent, a solvent containing at least a cyclic carbonate derivative represented by the following formula (1) and 1,2-dimethoxyethane and having other solvent properly mixed therewith is useful.

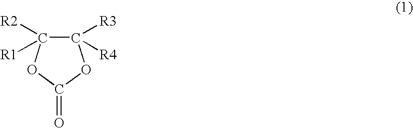

In the foregoing formula (1), R1 to R4 each independently represents a hydrogen group, a fluorine group, an alkyl group (for example, a methyl group, an ethyl group, etc.) or a fluoroalkyl group, and at least one of R1 to R4 contains fluorine.

Examples of the cyclic carbonate derivative represented by the formula (1) include 4-fluoro-1,3-dioxolan-2-one represented by the following formula (2) and 4,5-difluoro-1,3-dioxolan-2-one represented by the following formula (3). A content of 4-fluoro-1,3-dioxolan-2-one which is contained in the electrolytic solution (or the non-aqueous solvent) is preferably 1 wt % or more and 7 wt % or less. This is because when the content of 4-fluoro-1,3-dioxolan-2-one is less than 1 wt %, the effects are weak, whereas when it is more than 7 wt %, a film derived from 4-fluoro-1,3-dioxolan-2-one is excessively formed, whereby the resistance increases. When the resistance increases, it is difficult to bring out the best in a high output characteristic of the positive electrode material having an olivine structure.

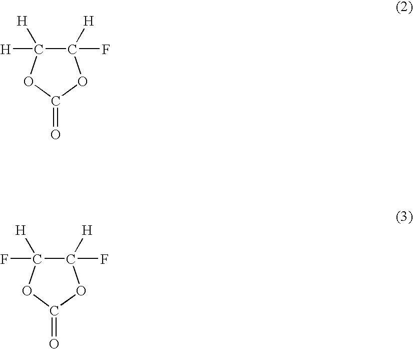

A content of 1,2-dimethoxyethane which is contained in the electrolytic solution (or the non-aqueous solvent) is preferably 1 wt % or more and 15 wt % or less, and more preferably 5 wt % or more and 10 wt % or less. This is because when the content of 1,2-dimethoxyethane is less than 1 wt %, the effects are weak, whereas when it is more than 10 wt %, a high-temperature storage characteristic is lowered. Also, this is because when the content of 1,2-dimethoxyethane is more than 15 wt %, influences against the negative electrode material become large so that excellent battery characteristics are not obtainable.

Examples of other solvent include cyclic carbonates such as ethylene carbonate, propylene carbonate and γ-butyrolactone; and chain carbonates such as diethyl carbonate, dimethyl carbonate, ethylmethyl carbonate and methylpropyl carbonate.

A lithium salt is useful as the electrolyte salt. Examples of the lithium salt include LiPF₆, LiBF₄, LiAsF₆, LiSbF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, LiBF₂(ox) [lithium difluorooxalate borate], LiBOB (lithium bisoxalate borate) and LiBr. These materials are used singly or in admixture of two or more kinds thereof. Above all, LiPF₆ is preferable because not only high ionic conductivity is obtainable, but the cycle characteristic can be enhanced.

[Manufacturing Method of Lithium Ion Secondary Battery]

This secondary battery can be, for example, manufactured in the following manner. First of all, for example, a positive electrode active material, a conductive agent and a binder are mixed to prepare a positive electrode mixture; and this positive electrode mixture is dispersed in a solvent such as N-methylpyrrolidone to form a positive electrode mixture slurry. Subsequently, this positive electrode mixture slurry is coated on the positive electrode collector 21A, and after drying the solvent, the resultant is subjected to compression molding by a roll press or the like, thereby forming the positive electrode active material 21B. There is thus prepared the positive electrode 21.

Also, for example, a negative electrode active material and a binder are mixed to prepare a negative electrode mixture, and this negative electrode mixture is dispersed in a solvent such as N-methylpyrrolidone to form a negative electrode mixture slurry. Subsequently, this negative electrode mixture slurry is coated on the negative electrode collector 22A, and after drying the solvent, the resultant is subjected to compression molding by a roll press or the like, thereby forming the negative electrode active material 22B. There is thus prepared the negative electrode 22.

Subsequently, the positive electrode lead 25 is installed in the positive electrode collector 21A by means of welding, etc., and the negative electrode lead 26 is also installed in the negative electrode collector 22A by means of welding, etc. Thereafter, the positive electrode 21 and the negative electrode 22 are wound via the separator 23; a tip of the positive electrode lead 25 is welded to the safety valve mechanism 15; and a tip of the negative electrode lead 26 is also welded to the battery can 11, thereby housing the wound positive electrode 21 and negative electrode 22 in the inside of the battery can 11 while being interposed between the pair of the insulating plates 12 and 13.

After housing the positive electrode 21 and the negative electrode 22 in the inside of the battery can 11, the foregoing electrolytic solution is injected into the inside of the battery can 11 and impregnated in the separator 23. Thereafter, the battery lid 14, the safety valve mechanism 15 and the temperature coefficient element 16 are fixed to the open end of the battery can 11 via the gasket 17 by caulking. There can be thus manufactured the secondary battery shown in FIG. 1.

In this secondary battery, when charge is carried out, for example, a lithium ion is deintercalated from the positive electrode 21 and intercalated into the negative electrode 22 via the electrolytic solution. When discharge is carried out, for example, a lithium ion is deintercalated from the negative electrode 22 and intercalated into the positive electrode 21 via the electrolytic solution.

In the lithium ion secondary battery according to the embodiment of the present invention, when a fluorine-containing cyclic carbonate derivative such as 4-fluoro-1,3-dioxolan-2-one to an electrolytic solution, even when an electrolytic solution containing 1,2-dimethoxyethane is used, a phenomenon where reversibility of a negative electrode carbon material is lowered can be suppressed. Accordingly, the addition amount of 1,2-dimethoxyethane can be increased; and conductivity of the electrolytic solution can be more enhanced. Low conductivity as seen in the case of using a negative electrode material having an olivine structure can be compensated.

Specific working examples of the present application are hereunder described in detail, but it should not be construed that the present application is limited thereto.

<Sample 1>

92 parts by mass of a carbon material obtained by graphitizing coal tar pitch at a temperature of 2800° C., 8 parts by mass of polyvinylidene fluoride and a generous amount of N-methyl-2-pyrrolidone were kneaded to obtain a negative electrode mixture coating material. This negative electrode mixture coating material was coated on the both surfaces of a copper foil having a thickness of 15 μm, dried and then pressed to prepare a strip-shaped negative electrode.

Prescribed amounts of Li₂CO₃, FeSO₄.7H₂O and NH₄H₂PO₄ were mixed, and the mixed powder and carbon black were mixed in a weight ratio of 97/3 and then dry mixed by a ball mill for 10 hours. The resulting mixed powder was baked in a nitrogen atmosphere at 550° C., thereby obtaining a carbon-coated lithium phosphate compound having an olivine structure and represented by LiFePO₄ as a positive electrode active material.

85 parts by mass of this lithium phosphate compound, 10 parts by mass of polyvinylidene fluoride, 5 parts by mass of artificial graphite and a generous amount of N-methyl-2-pyrrolidone were kneaded to obtain a positive electrode mixture coating material. This positive electrode mixture coating material was coated on the both surfaces of an aluminum foil having a thickness of 15 μm, dried and then pressed to prepare a strip-shaped positive electrode.

A polypropylene-made microporous film having a thickness of 25 μm was interposed between the positive electrode and the negative electrode and wound, and the wound body was put in a metal case having a diameter of 18 mm and a height of 65 mm together with a non-aqueous electrolytic solution, thereby preparing a cylindrical cell of Sample 1 of a 18650 size having a capacity of 1 Ah. As the non-aqueous electrolytic solution, a solution obtained by dissolving 1 mole/L of LiPF6 in a mixed solvent of ethylene carbonate (EC), 4-fluoro-1,3-dioxolan-2-one (FEC), dimethyl carbonate (DMC) and 1,2-dimethoxyethane (DME) in a ratio of ethylene carbonate (EC) to 4-fluoro-1,3-dioxolan-2-one (FEC) to dimethyl carbonate (DMC) to 1,2-dimethoxyethane (DME) of 20/5/65/10 (by weight).

<Sample 2>

A cylindrical cell of Sample 2 was prepared in the same manner as in the preparation of Sample 1, except for changing the composition of the mixed solvent so as to have a ratio of ethylene carbonate (EC) to 4-fluoro-1,3-dioxolan-2-one (FEC) to dimethyl carbonate (DMC) to 1,2-dimethoxyethane (DME) of 20/5/74/1 (by weight).

<Sample 3>

A cylindrical cell of Sample 3 was prepared in the same manner as in the preparation of Sample 1, except for changing the composition of the mixed solvent so as to have a ratio of ethylene carbonate (EC) to 4-fluoro-1,3-dioxolan-2-one (FEC) to dimethyl carbonate (DMC) to 1,2-dimethoxyethane (DME) of 20/5/60/15 (by weight).

<Sample 4>

A cylindrical cell of Sample 4 was prepared in the same manner as in the preparation of Sample 1, except for changing the composition of the mixed solvent so as to have a ratio of ethylene carbonate (EC) to 4-fluoro-1,3-dioxolan-2-one (FEC) to dimethyl carbonate (DMC) to 1,2-dimethoxyethane (DME) of 24/1/65/10 (by weight).

<Sample 5>

A cylindrical cell of Sample 5 was prepared in the same manner as in the preparation of Sample 1, except for changing the composition of the mixed solvent so as to have a ratio of ethylene carbonate (EC) to 4-fluoro-1,3-dioxolan-2-one (FEC) to dimethyl carbonate (DMC) to 1,2-dimethoxyethane (DME) of 18/7/65/10 (by weight).

<Sample 6>

A cylindrical cell of Sample 6 was prepared in the same manner as in the preparation of Sample 1, except for changing the composition of the mixed solvent so as to have a ratio of ethylene carbonate (EC) to 4,5-difluoro-1,3-dioxolan-2-one (DFEC) to dimethyl carbonate (DMC) to 1,2-dimethoxyethane (DME) of 20/5/65/10 (by weight).

<Sample 7>

A cylindrical cell of Sample 7 was prepared in the same manner as in the preparation of Sample 1, except for changing the composition of the mixed solvent so as to have a ratio of ethylene carbonate (EC) to dimethyl carbonate (DMC) to 1,2-dimethoxyethane (DME) of 25/65/10 (by weight).

<Sample 8>

A cylindrical cell of Sample 8 was prepared in the same manner as in the preparation of Sample 1, except for changing the composition of the mixed solvent so as to have a ratio of ethylene carbonate (EC) to 4-fluoro-1,3-dioxolan-2-one (FEC) to dimethyl carbonate (DMC) to 1,2-dimethoxyethane (DME) of 20/5/55/20 (by weight).

<Sample 9>

A cylindrical cell of Sample 9 was prepared in the same manner as in the preparation of Sample 1, except for changing the composition of the mixed solvent so as to have a ratio of ethylene carbonate (EC) to 4-fluoro-1,3-dioxolan-2-one (FEC) to dimethyl carbonate (DMC) to 1,2-dimethoxyethane (DME) of 15/10/55/20 (by weight).

<Sample 10>

A cylindrical cell of Sample 10 was prepared in the same manner as in the preparation of Sample 1, except for using lithium manganate having a spinel structure as the positive electrode active material.

<Sample 11>

A cylindrical cell of Sample 11 was prepared in the same manner as in the preparation of Sample 1, except for changing the composition of the mixed solvent so as to have a ratio of ethylene carbonate (EC) to 4-fluoro-1,3-dioxolan-2-one (FEC) to dimethyl carbonate (DMC) to 1,2-dimethoxyethane (DME) of 15/10/74.5/0.5 (by weight).

<Sample 12>

A cylindrical cell of Sample 12 was prepared in the same manner as in the preparation of Sample 1, except for changing the composition of the mixed solvent so as to have a ratio of ethylene carbonate (EC) to 4-fluoro-1,3-dioxolan-2-one (FEC) to dimethyl carbonate (DMC) to 1,2-dimethoxyethane (DME) of 24.5/0.5/65/10 (by weight).

<Sample 13>

A cylindrical cell of Sample 13 was prepared in the same manner as in the preparation of Sample 1, except for changing the composition of the mixed solvent so as to have a ratio of ethylene carbonate (EC) to dimethyl carbonate (DMC) to 1,2-dimethoxyethane (DME) to vinylene carbonate (VC) of 24/65/10/1 (by weight).

[Test]

Samples 1 to 13 were tested in the following manner.

[Initial Charge and Discharge Efficiency]

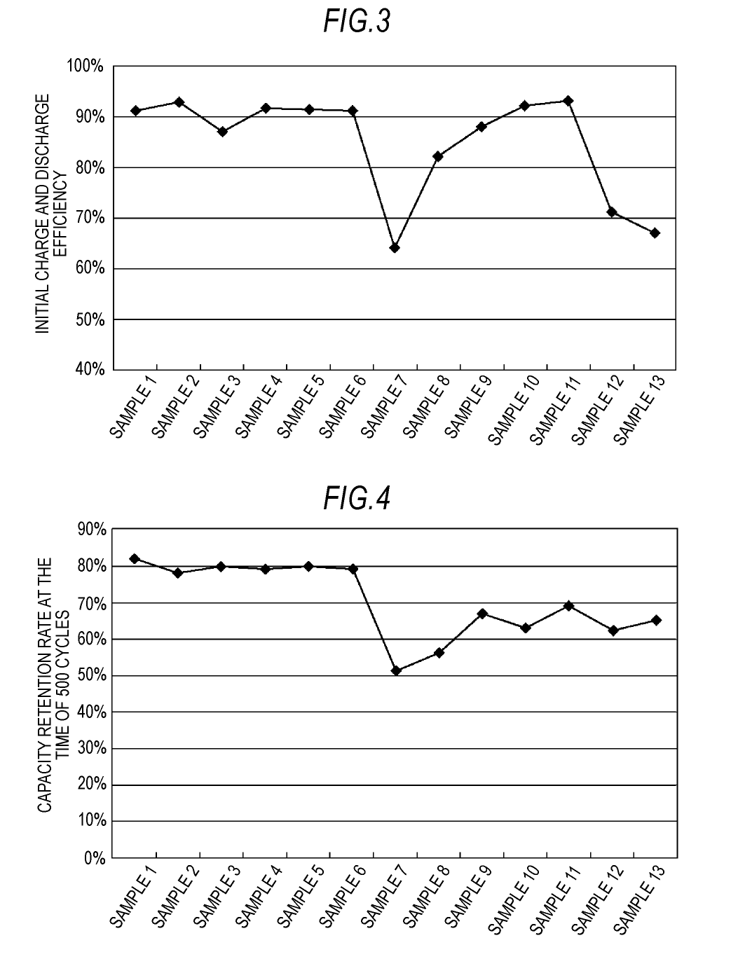

With respect to each of Samples 1 to 9 and 11 to 13, after preparing the cylindrical cell, charge was carried out once by constant-current and constant-voltage charge (condition: 0.2 A, 3.6 V, 12 hours); and thereafter, discharge was carried out once by constant-current discharge (condition: 0.2 A, 2.0 V), thereby measuring a charge capacity and a discharge capacity, from which was then calculated a charge and discharge efficiency calculated by ((discharge capacity)/(charge capacity))×100 [%]. With respect to Sample 10, after preparing the cylindrical cell, charge was carried out once by constant-current and constant-voltage charge (condition: 0.2 A, 4.2 V, 12 hours); and thereafter, discharge was carried out once by constant-current discharge (condition: 0.2 A, 3.0 V), thereby measuring a charge capacity and a discharge capacity, from which was then calculated a charge and discharge efficiency calculated by ((discharge capacity)/(charge capacity))×100 [%]. The thus determined initial charge and discharge efficiencies are shown in Table 1. Also, the determined initial charge and discharge efficiencies of Samples 1 to 13 are summarized into a graph. This graph is shown in FIG. 3.

[Evaluation of Cycle Characteristic]

With respect to each of Samples 1 to 9 and 11 to 13, a cycle test of repeating constant-current and constant-voltage charge (condition: 2 A, 3.6 V, 0.1 A cut) and constant-current discharge (condition: 3 A, 2.0 V) was carried out, thereby determining a capacity retention rate of a discharge capacity at the time of 500 cycles to a discharge capacity at the time of one cycle. With respect to Sample 10, a cycle test of repeating constant-current and constant-voltage charge (condition: 2 A, 4.2 V, 0.1 A cut) and constant-current discharge (condition: 3 A, 3.0 V) was carried out, thereby determining a capacity retention rate of a discharge capacity at the time of 500 cycles to a discharge capacity at the time of one cycle. The thus determined capacity retention rates are shown in Table 1. Also, the determined capacity retention rates of Samples 1 to 13 are summarized into a graph. This graph is shown in FIG. 4.

[Measurement of Direct Current Resistance]

With respect to the cylindrical cells of Samples 1 to 13, discharge with 20 A was carried out from a fully charged state, and a direct current resistance was calculated according to the following expression (1) using a voltage V1 after 5 seconds and a voltage V0 immediately before the discharge.

Direct current=(V0−V1)/20 Expression 1

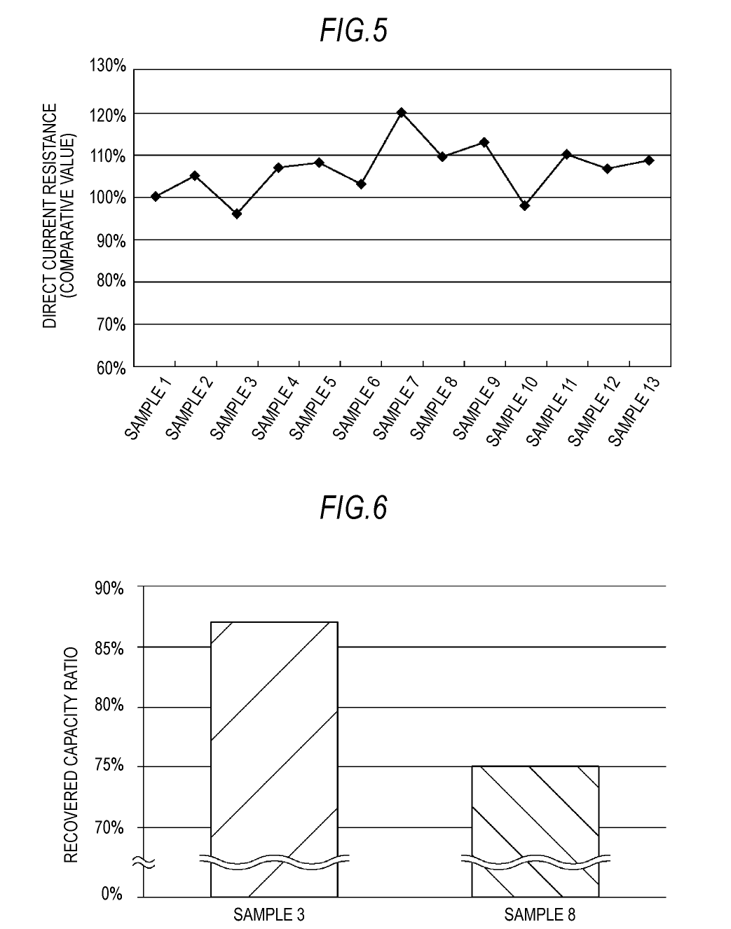

A comparative value was calculated from the determined direct current resistance value while defining a direct current resistance value of Sample 7 as 100%. The comparative values are shown in Table 1. Also, the comparative values of direct current resistance of Samples 1 to 13 are summarized into a graph. This graph is shown in FIG. 5.

[Evaluation of High-Temperature Storage]

With respect to each of the cylindrical cells of Samples 3 and 8, charge and discharge were repeated twice by constant-current and constant-voltage charge (condition: 1 A, 3.6 V, 0.1 A cut) and constant-current discharge (condition: 0.2 A, 2.0 V); charge was again carried out once; and each cylindrical cell was then allowed to stand at 60° C. for one week. Thereafter, the resulting cylindrical cell was allowed to stand until the temperature returned to room temperature and was then subjected to charge and discharge once by constant-current discharge (condition: 0.2 A, 2.0 V), constant-current and constant-voltage charge (condition: 1 A, 3.6 V, 0.1 A cut) and constant-current discharge (condition: 0.2 A, 2.0 V) in this order, thereby defining a final discharge capacity as a recovered capacity. A recovered capacity ratio was determined while defined a discharge capacity immediately before standing at 60° C. as 100%. The determined recovered capacity ratios are shown in Table 1. Also, the determined recovered capacity ratios are summarized into a graph. This graph is shown in FIG. 6.

TABLE 1

| | | | | | | | | Initial | Discharge | Direct current | Recovered |
|---|---|---|---|---|---|---|---|---|---|---|---|
| | Positive | Electrolytic solution [wt %] | | | | | | efficiency | cycle with 3 A | resistance of | capacity after |
| | electrode | EC | FEC | DFEC | DMC | DME | VC | [%] | [%] | cell [%] | storage at 60° C. [%] |
| Sample 1 | LiFePO₄ | 20 | 5 | — | 65 | 10 | — | 91.0 | 82 | 100 | — |
| Sample 2 | LiFePO₄ | 20 | 5 | — | 74 | 1 | — | 92.8 | 78 | 105 | — |
| Sample 3 | LiFePO₄ | 20 | 5 | — | 60 | 15 | — | 87.0 | 80 | 96 | 87 |
| Sample 4 | LiFePO₄ | 24 | 1 | — | 65 | 10 | — | 91.5 | 79 | 107 | — |
| Sample 5 | LiFePO₄ | 18 | 7 | — | 65 | 10 | — | 91.3 | 80 | 108 | — |
| Sample 6 | LiFePO₄ | 20 | — | 5 | 65 | 10 | — | 91.1 | 79 | 103 | — |
| Sample 7 | LiFePO₄ | 25 | — | — | 65 | 10 | — | 64.0 | 51 | 120 | — |
| Sample 8 | LiFePO₄ | 20 | 5 | — | 55 | 20 | — | 82.0 | 56 | 110 | 75 |
| Sample 9 | LiFePO₄ | 15 | 10 | — | 55 | 20 | — | 88.0 | 67 | 113 | — |
| Sample 10 | LiMn₂O₄ | 20 | 5 | — | 65 | 10 | — | 92.0 | 63 | 98 | — |
| Sample 11 | LiFePO₄ | 15 | 10 | — | 74.5 | 0.5 | — | 93.0 | 69 | 110 | — |
| Sample 12 | LiFePO₄ | 24.5 | 0.5 | — | 65 | 10 | — | 71.0 | 62 | 107 | — |
| Sample 13 | LiFePO₄ | 24 | — | — | 65 | 10 | 1 | 67.0 | 65 | 109 | — |

EC: Ethylene carbonate,
FEC: 4-Fluoro-1,3-dioxolan-2-one,
DFEC: 4,5-Difluoro-1,3-dioxolan-2-one,
DMC: Dimethyl carbonate
DME: 1,2-Dimethoxyethane,
VC: Vinylene carbonate

[Evaluation]

[Comparison with Sample 7]

As shown in Table 1 and FIGS. 3 to 5, Samples 1 to 5, Samples 8 to 9 and Samples 11 to 12 were more favorable than Sample 7 with respect to the initial charge and discharge efficiency, cycle characteristic and direct current resistance. The reason why this result was obtained resides in the fact that in Samples 1 to 5, Samples 8 to 9 and Samples 11 to 12, 1,2-dimethoxyethane (DME) and 4-fluoro-1,3-dioxolan-2-one (FEC) were used jointly.

Sample 6 was more favorable than Sample 7 with respect to the initial charge and discharge efficiency, cycle characteristic and direct current resistance. The reason why this result was obtained resides in the fact that in Sample 6, 1,2-dimethoxyethane (DME) and 4,5-difluoro-1,3-dioxolan-2-one (DFEC) were used jointly.

[Re: Initial Efficiency]

As shown in Table 1 and FIG. 3, in Samples 1 to 5, though 1,2-dimethoxyethane (DME) was used, 4-fluoro-1,3-dioxolan-2-one (FEC) was used jointly, and therefore, the initial efficiency was favorable. In Sample 7, though 1,2-dimethoxyethane (DME) was used, 4-fluoro-1,3-dioxolan-2-one (FEC) was not used jointly, and therefore, the initial efficiency was worse. In Sample 12, though 4-fluoro-1,3-dioxolan-2-one (FEC) and 1,2-dimethoxyethane (DME) were used jointly, the amount of 4-fluoro-1,3-dioxolan-2-one (FEC) was too low so that the initial efficiency was worse.

[Re: Cycle Characteristic]

As shown in Table 1 and FIG. 4, in Samples 1 to 5, the amount of each of 1,2-dimethoxyethane (DME) and 4-fluoro-1,3-dioxolan-2-one (FEC) was appropriate, and the cycle characteristic was favorable. In Samples 8 and 9, the amount of 1,2-dimethoxyethane (DME) was too large so that the cycle characteristic was worse. In Sample 12, the amount of 4-fluoro-1,3-dioxolan-2-one (FEC) was too low so that the cycle characteristic was worse. In Sample 10, since LiMn2O4 having a higher positive electrode potential than that of LiFePO4 was used, the amount of decomposition of 1,2-dimethoxyethane (DME) was large, and the cycle characteristic was worse.

[Direct Current Resistance]

As shown in Table 1 and FIG. 5, in Samples 1 to 5 and Sample 10, the amount of 1,2-dimethoxyethane (DME) was appropriate, and the direct current resistance was small. In Sample 7, since 1,2-dimethoxyethane (DME) and 4-fluoro-1,3-dioxolan-2-one (FEC) were not used jointly, decomposition of 1,2-dimethoxyethane (DME) proceeded, and the direct current resistance was the largest. In Samples 8 to 9, the amount of 1,2-dimethoxyethane (DME) was too large so that the direct current resistance was large. In Sample 11, the amount of 1,2-dimethoxyethane (DME) was too small so that the direction current resistance was large.

[High-Temperature Storage Characteristic]

As shown in Table 1 and FIG. 6, in Sample 3, since the amount of 1,2-dimethoxyethane (DME) was appropriate, the high-temperature storage characteristic was favorable. On the other hand, in Sample 9, the amount of 1,2-dimethoxyethane (DME) was too large so that the high-temperature storage characteristic was worse.

[Others]

As shown in Table 1 and FIGS. 3 to 5, according to Sample 1 and Sample 13, even when vinylene carbonate (VC) was used in place of 4-fluoro-1,3-dioxolan-2-one (FEC), favorable characteristics were not obtained.

It should not be construed that the present application is limited to the foregoing embodiment. Various modifications and applications can be made therein so far as the scope of the present application is not deviated. For example, in the foregoing embodiment according to the present application, the battery of a cylinder type has been described as an example, but it should not be construed that the present invention is limited thereto. The non-aqueous electrolyte battery according to an embodiment is similarly applicable to batteries having various shapes and sizes, such as batteries using a metal-made container, for example, rectangular type batteries, coin type batteries, button type batteries, etc. and batteries using a laminated film, etc. as an exterior material, for example, thin type batteries. Also, the non-aqueous electrolyte battery according to the embodiment of the present invention is applicable to not only a secondary battery but a primary battery.

Also, other electrolytes, for example, electrolytes in a gel form in which an electrolytic solution is held on a polymer compound, may be used in place of the electrolytic solution. The electrolytic solution (namely, one containing a liquid solvent, an electrolyte salt and additives) is the foregoing electrolytic solution. Examples of the polymer compound include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxanes, polyvinyl acetate, polyvinyl alcohol, polymethyl methacrylate, polyacrylic acid, polymethacrylic acid, styrene-butadiene rubbers, nitrile-butadiene rubbers, polystyrene and polycarbonates. In particular, taking into consideration electrochemical stability, polyacrylonitrile, polyvinylidene fluoride, polyhexafluoropropylene, polyethylene oxide and the like are preferable.

Also, examples of other electrolyte include polymer solid electrolytes using an ionic conductive polymer and inorganic solid electrolytes using an ionic conductive inorganic material. These materials may be used singly or in combinations with other electrolyte. Examples of the polymer compound which can be used for the polymer solid electrolyte include polyethers, polyesters, polyphosphazene and polysiloxanes. Examples of the inorganic solid electrolyte include an ionic conductive ceramic, an ionic conductive crystal and an ionic conductive glass.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A non-aqueous electrolyte battery comprising:
a positive electrode containing a lithium phosphate compound having an olivine structure;
a negative electrode containing a negative electrode active material capable of doping and dedoping lithium; and
a non-aqueous electrolyte,
the non-aqueous electrolyte containing a cyclic carbonate derivative represented by the following formula (1) and 1,2-dimethoxyethane 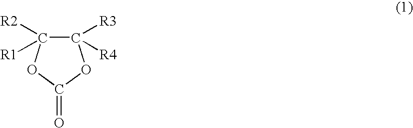
wherein R1 to R4 each independently represents a hydrogen group, a fluorine group, an alkyl group or a fluoroalkyl group, and at least one of R1 to R4 contains fluorine.

2. The non-aqueous electrolyte battery according to claim 1, wherein the lithium phosphate compound is lithium iron phosphate represented by LiFePO4.

3. The non-aqueous electrolyte battery according to claim 1, wherein the cyclic carbonate derivative is at least one member selected from the group consisting of 4-fluoro-1,3-dioxolan-2-one represented by the following formula (2) and 4,5-difluoro-1,3-dioxolan-2-one represented by the following formula (3)

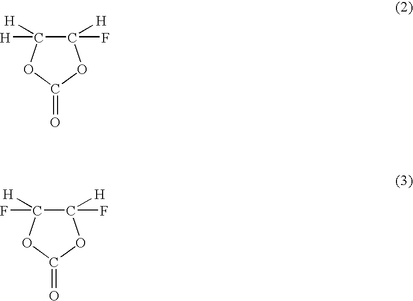

4. The non-aqueous electrolyte battery according to claim 1, wherein a content of the cyclic carbonate derivative is 1 wt % or more and 7 wt % or less.

5. The non-aqueous electrolyte battery according to claim 1, wherein a content of the 1,2-dimethoxyethane is 1 wt % or more and 15 wt % or less.

6. The non-aqueous electrolyte battery according to claim 1, wherein a content of the cyclic carbonate derivative is 1 wt % or more and 7 wt % or less; and
a content of the 1,2-dimethoxyethane is 1 wt % or more and 15 wt % or less.

7. The non-aqueous electrolyte battery according to claim 1, wherein a content of the 1,2-dimethoxyethane is 5 wt % or more and 10 wt % or less.

8. The non-aqueous electrolyte battery according to claim 1, wherein the negative electrode active material contains a carbon material.
